(19) United States
(12) Patent Application Publication
(10) Pub. No.: US 2021/0160740 A1
(43) Pub. Date: May 27, 2021

(54) TRANSMITTING/RECEIVING METHOD FOR ENSURING CONNECTIVITY IN WIRE-LESS COMMUNICATION SYSTEM, AND DEVICE THEREFOR

(71) Applicant: LG ELECTRONICS INC., Seoul (KR)

(72) Inventors: Laeyoung KIM, Seoul (KR); Sungduck CHUN, Seoul (KR)

(73) Assignee: LG ELECTRONICS INC., Seoul (KR)

(21) Appl. No.: 17/267,668

(22) PCT Filed: Aug. 13, 2019
(86) PCT No.: PCT/KR2019/010293

§ 371 Date: Feb. 10, 2021

(30) Foreign Application Priority Data
Aug. 13, 2018 (KR) 10-2018-0094266

(51) Int. Cl. H04W 28/26; H04W 48/18; H04W 8/08; H04W 28/02

(52) U.S. Cl. CPC H04W 28/26; H04W 28/0268; H04W 8/08; H04W 48/18

(57) ABSTRACT

In one embodiment of the present invention, a method by which an access and mobility management function (AMF) transmits/receives a signal for ensuring connectivity in a wireless communication system comprises the steps of: selecting, by the AMF, at least one next generation radio access network (NG-RAN) on a moving path of a user equipment (UE); and providing, by the AMF, a QoS reservation profile to the selected at least one NG-RAN, wherein the QoS reservation profile includes at least one piece of information about the UE, information about a flow/PDU session for which a resource reservation is required, required QoS-related information, a resource reservation start time and a resource reservation end time.

### TECHNICAL FIELD

The present disclosure relates to a wireless communication system, and more specifically, to a method in which AMF transmits and receives a signal for ensuring connectivity, and a device for performing the method.

### BACKGROUND ART

Wireless communication systems have been widely deployed to provide various types of communication services such as voice or data. In general, a wireless communication system is a multiple access system that supports communication of multiple users by sharing available system resources (a bandwidth, transmission power, etc.) among them. For example, multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi-carrier frequency division multiple access (MC-FDMA) system.

Wireless communication systems adopt various radio access technologies (RATs) such as long term evolution (LTE), LTE-advanced (LTE-A), and wireless fidelity (WiFi). 5th generation (5G) is one of them. Three key requirement areas of 5G include (1) enhanced mobile broadband (eMBB), (2) massive machine type communication (mMTC), and (3) ultra-reliable and low latency communications (URLLC). Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, and media and entertainment applications in the cloud or augmented reality (AR). Data is one of the key drivers for 5G and in the 5G era, we may see no dedicated voice service for the first time. In 5G, voice is expected to be handled as an application program, simply using data connectivity provided by a communication system. The main drivers for an increased traffic volume are the increase in the size of content and the number of applications requiring high data rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is augmented reality (AR) for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IoT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now, multiple use cases will be described in greater detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information on top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost- and energy-efficient maintenance of the city or home. A similar setup may be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G.

Finally, logistics and freight tracking are important use cases for mobile communications that enable the tracking of inventory and packages wherever they are by using location-based information systems. The logistics and freight tracking use cases typically require lower data rates but need wide coverage and reliable location information.

### DISCLOSURE

### Technical Purpose

A purpose of the present disclosure is to provide a method for transmitting and receiving a signal between AMF and other nodes to ensure connectivity.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

An aspect of the present disclosure provides a method for transmitting and receiving, by an access and mobility management function (AMF), a signal to ensure connectivity in a wireless communication system, the method comprising: selecting, the AMF, at least one next generation radio access network (NG-RAN) on a moving path of a user equipment (UE); and providing, by the AMF, a QoS reservation profile to the selected at least one NG-RAN, wherein the QoS reservation profile includes at least one of information on the UE, information on a Flow/PDU session for which resource reservation is required, information on required QoS, a resource reservation start timing, and a resource reservation termination timing.

Another aspect of the present disclosure provides an access and mobility management function (AMF) device in a wireless communication system, the device comprising: a memory; and at least one processor coupled to the memory, wherein the at least one processor is configured to: select at least one next generation radio access network (NG-RAN) on a moving path of a user equipment (UE); and provide a QoS reservation profile to the selected at least one NG-RAN, wherein the QoS reservation profile includes at least one of information on the UE, information on a Flow/PDU session for which resource reservation is required, information on required QoS, a resource reservation start timing, and a resource reservation termination timing.

In one implementation, the QoS reservation profile is configured to allow the at least one NG-RAN to perform resource reservation for a Flow/PDU session.

In one implementation, handover to the at least one NG-RAN that has performed the resource reservation for a Flow/PDU session is always allowed.

In one implementation, when performing the handover for the Flow/PDU session, a target NG-RAN determines a next target NG-RAN.

In one implementation, the resource reservation is performed for a time duration between the resource reservation start timing and the resource reservation termination timing.

In one implementation, each of the resource reservation start timing and the resource reservation termination timing is set for each NG-RAN.

In one implementation, the at least one NG-RAN is selected when the PDU session is created, when the UE is in a connected mode, when a user plane of the PDU session is activated, when the PDU session is modified, when the UE is registered, or when handover is performed.

In one implementation, the QoS reservation profile is provided to the selected at least one NG-RAN when the PDU session is created.

In one implementation, the QoS reservation profile is provided to the selected at least one NG-RAN when the AMF provides a QoS profile to a serving NG-RAN of the UE.

In one implementation, when the at least one NG-RAN performs admission control, the QoS reservation profile is configured such that the at least one NG-RAN considers non-activated Flow/PDU session as being activated.

In one implementation, the NG-RAN is determined based on at least one of network configuration information, region information, a moving path and a speed of the UE, and a network congestion level.

### Technical Effects

According to the present disclosure, the connectivity is ensured and thus, services such as autonomous driving may be continuously provided.

It will be appreciated by persons skilled in the art that the effects that may be achieved with the present disclosure are not limited to what has been particularly described hereinabove and other advantages of the present disclosure will be more clearly understood from the following detailed description taken in conjunction with the accompanying drawings.

### BRIEF DESCRIPTIONS OF DRAWINGS

The accompanying drawings, which are included to provide a further understanding of the present disclosure and are incorporated in and constitute a part of this application, illustrate embodiments of the present disclosure and together with the description serve to explain the principle of the disclosure.

FIG. 1 is a schematic diagram illustrating the structure of an evolved packet system (EPS) including an evolved packet core (EPC).

FIG. 2 is a diagram illustrating the general architectures of an E-UTRAN and an EPC.

FIG. 3 is a diagram illustrating the structure of a radio interface protocol in a control plane.

FIG. 4 is a diagram illustrating the structure of a radio interface protocol in a user plane.

FIG. 5 is a flowchart illustrating a random access procedure.

FIG. 6 is a diagram illustrating a connection process in a radio resource control (RRC) layer.

FIG. 7 is a diagram illustrating a 5th generation (5G) system.

FIG. 8 to FIG. 13 are diagrams for describing an embodiment of the present disclosure.

FIG. 14 is a diagram illustrating a configuration of a node device according to an embodiment of the present disclosure.

### DETAILED DESCRIPTIONS

The embodiments below are combinations of components and features of the present disclosure in a prescribed form. Each component or feature may be considered as selective unless explicitly mentioned as otherwise. Each component or feature may be executed in a form that is not combined with other components and features. Further, some components and/or features may be combined to configure an embodiment of the present disclosure. The order of operations described in the embodiments of the present disclosure may be changed. Some components or features of an embodiment may be included in another embodiment or may be substituted with a corresponding component or feature of the present disclosure.

Specific terms used in the description below are provided to help an understanding of the present disclosure, and the use of such specific terms may be changed to another form within the scope of the technical concept of the present disclosure.

In some cases, in order to avoid obscurity of the concept of the present disclosure, a known structure and apparatus may be omitted, or a block diagram centering on core functions of each structure or apparatus may be used. Moreover, the same reference numerals are used for the same components throughout the present specification.

The embodiments of the present disclosure may be supported by standard documents disclosed with respect to at least one of IEEE (Institute of Electrical and Electronics Engineers) 802 group system, 3GPP system, 3GPP LTE & LTE-A system and 3GPP2 system. Namely, the steps or portions having not been described in order to clarify the technical concept of the present disclosure in the embodiments of the present disclosure may be supported by the above documents. Furthermore, all terms disclosed in the present document may be described according to the above standard documents.

The technology below may be used for various wireless communication systems. For clarity, the description below centers on 3GPP LTE and 3GPP LTE-A, by which the technical idea of the present disclosure is non-limited.

Terms used in the present document are defined as follows.
UMTS (Universal Mobile Telecommunications System): a GSM (Global System for Mobile Communication) based third generation mobile communication technology developed by the 3GPP.
EPS (Evolved Packet System): a network system that includes an EPC (Evolved Packet Core) which is an IP (Internet Protocol) based packet switched core network and an access network such as LTE and UTRAN. This system is the network of an evolved version of the UMTS.
NodeB: a base station of GERAN/UTRAN. This base station is installed outdoor and its coverage has a scale of a macro cell.
eNodeB: a base station of LTE. This base station is installed outdoor and its coverage has a scale of a macro cell.
UE (User Equipment): the UE may be referred to as terminal, ME (Mobile Equipment), MS (Mobile Station), etc. Also, the UE may be a portable device such as a notebook computer, a cellular phone, a PDA (Personal Digital Assistant), a smart phone, and a multimedia device. Alternatively, the UE may be a non-portable device such as a PC (Personal Computer) and a vehicle mounted device. The term “UE”, as used in relation to MTC, may refer to an MTC device.
HNB (Home NodeB): a base station of UMTS network. This base station is installed indoor and its coverage has a scale of a micro cell.
HeNB (Home eNodeB): a base station of an EPS network. This base station is installed indoor and its coverage has a scale of a micro cell.
MME (Mobility Management Entity): a network node of an EPS network, which performs mobility management (MM) and session management (SM).
PDN-GW (Packet Data Network-Gateway)/PGW: a network node of an EPS network, which performs UE IP address allocation, packet screening and filtering, charging data collection, etc.
SGW (Serving Gateway): a network node of an EPS network, which performs mobility anchor, packet routing, idle-mode packet buffering, and triggering of an MME's UE paging.
NAS (Non-Access Stratum): an upper stratum of a control plane between a UE and an MME. This is a functional layer for transmitting and receiving a signaling and traffic message between a UE and a core network in an LTE/UMTS protocol stack, and supports mobility of a UE, and supports a session management procedure of establishing and maintaining IP connection between a UE and a PDN GW.
PDN (Packet Data Network): a network in which a server supporting a specific service (e.g., a Multimedia Messaging Service (MMS) server, a Wireless Application Protocol (WAP) server, etc.) is located.
PDN connection: a logical connection between a UE and a PDN, represented as one IP address (one IPv4 address and/or one IPv6 prefix).
RAN (Radio Access Network): a unit including a Node B, an eNode B, and a Radio Network Controller (RNC) for controlling the Node B and the eNode B in a 3GPP network, which is present between UEs and provides a connection to a core network.
HLR (Home Location Register)/HSS (Home Subscriber Server): a database having subscriber information in a 3GPP network. The HSS may perform functions such as configuration storage, identity management, and user state storage.
PLMN (Public Land Mobile Network): a network configured for the purpose of providing mobile communication services to individuals. This network may be configured per operator.
Proximity Services (or ProSe Service or Proximity-based Service): a service that enables discovery between physically proximate devices, and mutual direct communication/communication through a base station/communication through the third party. At this time, user plane data is exchanged through a direct data path without passing through a 3GPP core network (e.g., EPC).

EPC (Evolved Packet Core)

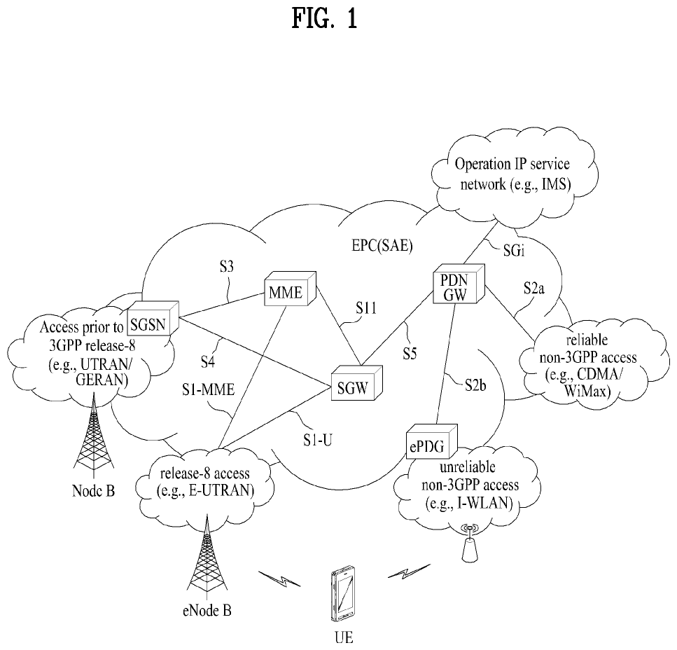

FIG. 1 is a schematic diagram showing the structure of an evolved packet system (EPS) including an evolved packet core (EPC).

The EPC is a core element of system architecture evolution (SAE) for improving performance of 3GPP technology. SAE corresponds to a research project for determining a network structure supporting mobility between various types of networks. For example, SAE aims to provide an optimized packet-based system for supporting various radio access technologies and providing an enhanced data transmission capability.

Specifically, the EPC is a core network of an IP mobile communication system for 3GPP LTE and may support real-time and non-real-time packet-based services. In conventional mobile communication systems (i.e. second-generation or third-generation mobile communication systems), functions of a core network are implemented through a circuit-switched (CS) sub-domain for voice and a packet-switched (PS) sub-domain for data. However, in a 3GPP LTE system which is evolved from the third generation communication system, CS and PS sub-domains are unified into one IP domain. That is, In 3GPP LTE, connection of terminals having IP capability may be established through an IP-based business station (e.g., an eNodeB (evolved Node B)), EPC, and an application domain (e.g., IMS). That is, the EPC is an essential structure for end-to-end IP services.

The EPC may include various components. FIG. 1 shows some of the components, namely, a serving gateway (SGW), a packet data network gateway (PDN GW), a mobility management entity (MME), a serving GPRS (general packet radio service) supporting node (SGSN) and an enhanced packet data gateway (ePDG).

SGW (or S-GW) operates as a boundary point between a radio access network (RAN) and a core network and maintains a data path between an eNodeB and the PDN GW. When. When a terminal moves over an area served by an eNodeB, the SGW functions as a local mobility anchor point. That is, packets. That is, packets may be routed through the SGW for mobility in an evolved UMTS terrestrial radio access network (E-UTRAN) defined after 3GPP release-8. In addition, the SGW may serve as an anchor point for mobility of another 3GPP network (a RAN defined before 3GPP release-8, e.g., UTRAN or GERAN (global system for mobile communication (GSM)/enhanced data rates for global evolution (EDGE) radio access network).

The PDN GW (or P-GW) corresponds to a termination point of a data interface for a packet data network. The PDN GW may support policy enforcement features, packet filtering and charging support. In addition, the PDN GW may serve as an anchor point for mobility management with a 3GPP network and a non-3GPP network (e.g., an unreliable network such as an interworking wireless local area network (I-WLAN) and a reliable network such as a code division multiple access (CDMA) or WiMax network).

Although the SGW and the PDN GW are configured as separate gateways in the example of the network structure of FIG. 1, the two gateways may be implemented according to a single gateway configuration option.

The MME performs signaling and control functions for supporting access of a UE for network connection, network resource allocation, tracking, paging, roaming and handover. The MME controls control plane functions associated with subscriber and session management. The MME manages numerous eNodeBs and signaling for selection of a conventional gateway for handover to other 2G/3G networks. In addition, the MME performs security procedures, terminal-to-network session handling, idle terminal location management, etc.

The SGSN handles all packet data such as mobility management and authentication of a user for other 3GPP networks (e.g., a GPRS network).

The ePDG serves as a security node for a non-3GPP network (e.g., an I-WLAN, a Wi-Fi hotspot, etc.).

As described above with reference to FIG. 1, a terminal having IP capabilities may access an IP service network (e.g., an IMS) provided by an operator via various elements in the EPC not only based on 3GPP access but also based on non-3GPP access.

Additionally, FIG. 1 shows various reference points (e.g. S1-U, S1-MME, etc.). In 3GPP, a conceptual link connecting two functions of different functional entities of an E-UTRAN and an EPC is defined as a reference point. Table 1 is a list of the reference points shown in FIG. 1. Various reference points may be present in addition to the reference points in Table 1 according to network structures.

TABLE 1

| Reference | |
|---|---|
| point | Description |
| S1-MME | Reference point for the control plane protocol between E-UTRAN and MME |
| S1-U | Reference point between E-UTRAN and Serving GW for the per bearer user plane |
| | tunneling and inter eNodeB path switching during handover |
| S3 | It enables user and bearer information exchange for inter 3GPP access network |
| | mobility in idle and/or active state. This reference point may be used intra-PLMN or |
| | inter-PLMN (e.g. in the case of Inter-PLMN HO). |
| S4 | It provides related control and mobility support between GPRS Core and the 3GPP |
| | Anchor function of Serving GW. In addition, when Direct Tunnel is not established, |
| | it provides the user plane tunneling. |
| S5 | It provides user plane tunneling and tunnel management between Serving GW and |
| | PDN GW. It is used for Serving GW relocation due to UE mobility and when the |
| | Serving GW needs to connect to a non-collocated PDN GW for the required PDN |
| | connectivity. |
| S11 | Reference point between an MME and an SGW |
| SGi | It is the reference point between the PDN GW and the packet data network. Packet |
| | data network may be an operator external public or private packet data network or |
| | an intra operator packet data network, e.g. for provision of IMS services. This |
| | reference point corresponds to Gi for 3GPP accesses. |

Among the reference points shown in FIG. 1, S2a and S2b correspond to non-3GPP interfaces. S2a is a reference point which provides reliable non-3GPP access and related control and mobility support between PDN GWs to a user plane. S2b is a reference point which provides related control and mobility support between the ePDG and the PDN GW to the user plane.

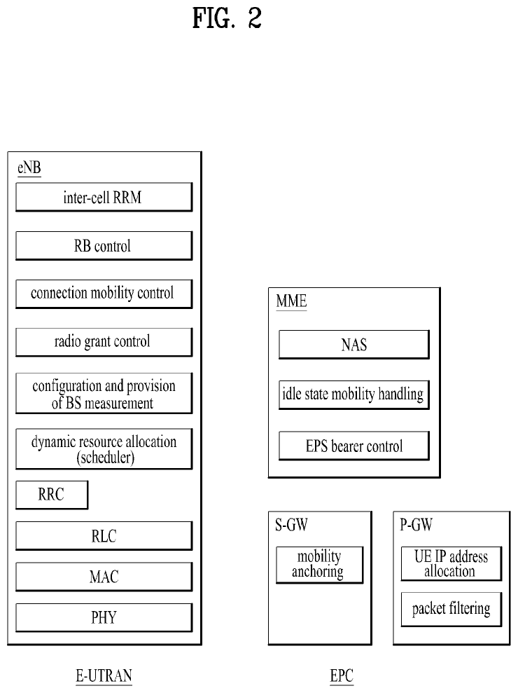

FIG. 2 is a diagram exemplarily illustrating architectures of a typical E-UTRAN and EPC.

As shown in the figure, while radio resource control (RRC) connection is activated, an eNodeB may perform routing to a gateway, scheduling transmission of a paging message, scheduling and transmission of a broadcast channel (BCH), dynamic allocation of resources to a UE on uplink and downlink, configuration and provision of eNodeB measurement, radio bearer control, radio admission control, and connection mobility control. In the EPC, paging generation, LTE IDLE state management, ciphering of the user plane, SAE bearer control, and ciphering and integrity protection of NAS signaling.

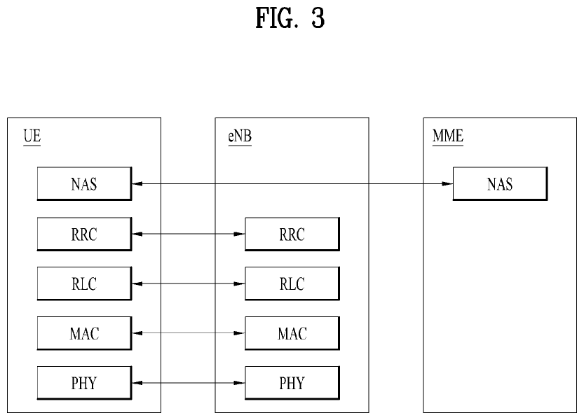

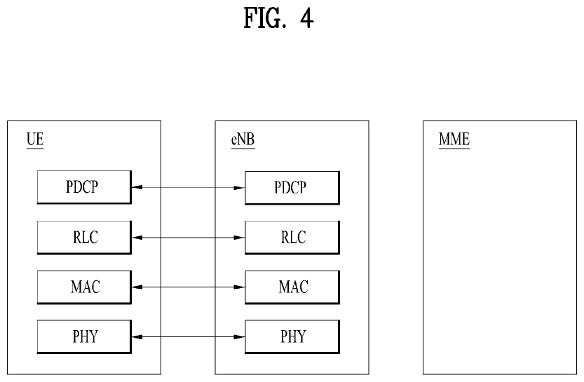

FIG. 3 is a diagram exemplarily illustrating the structure of a radio interface protocol in a control plane between a UE and a base station, and FIG. 4 is a diagram exemplarily illustrating the structure of a radio interface protocol in a user plane between the UE and the base station.

The radio interface protocol is based on the 3GPP wireless access network standard. The radio interface protocol horizontally includes a physical layer, a data link layer, and a networking layer. The radio interface protocol is divided into a user plane for transmission of data information and a control plane for delivering control signaling which are arranged vertically.

The protocol layers may be classified into a first layer (L1), a second layer (L2), and a third layer (L3) based on the three sublayers of the open system interconnection (OSI) model that is well known in the communication system.

Hereinafter, description will be given of a radio protocol in the control plane shown in FIG. 3 and a radio protocol in the user plane shown in FIG. 4.

The physical layer, which is the first layer, provides an information transfer service using a physical channel. The physical channel layer is connected to a medium access control (MAC) layer, which is a higher layer of the physical layer, through a transport channel. Data is transferred between the physical layer and the MAC layer through the transport channel. Transfer of data between different physical layers, i.e., a physical layer of a transmitter and a physical layer of a receiver is performed through the physical channel.

The physical channel consists of a plurality of subframes in the time domain and a plurality of subcarriers in the frequency domain. One subframe consists of a plurality of symbols in the time domain and a plurality of subcarriers. One subframe consists of a plurality of resource blocks. One resource block consists of a plurality of symbols and a plurality of subcarriers. A Transmission Time Interval (TTI), a unit time for data transmission, is 1 ms, which corresponds to one subframe.

According to 3GPP LTE, the physical channels present in the physical layers of the transmitter and the receiver may be divided into data channels corresponding to Physical Downlink Shared Channel (PDSCH) and Physical Uplink Shared Channel (PUSCH) and control channels corresponding to Physical Downlink Control Channel (PDCCH), Physical Control Format Indicator Channel (PCFICH), Physical Hybrid-ARQ Indicator Channel (PHICH) and Physical Uplink Control Channel (PUCCH).

The second layer includes various layers.

First, the MAC layer in the second layer serves to map various logical channels to various transport channels and also serves to map various logical channels to one transport channel. The MAC layer is connected with an RLC layer, which is a higher layer, through a logical channel. The logical channel is broadly divided into a control channel for transmission of information of the control plane and a traffic channel for transmission of information of the user plane according to the types of transmitted information.

The radio link control (RLC) layer in the second layer serves to segment and concatenate data received from a higher layer to adjust the size of data such that the size is suitable for a lower layer to transmit the data in a radio interval.

The Packet Data Convergence Protocol (PDCP) layer in the second layer performs a header compression function of reducing the size of an IP packet header which has a relatively large size and contains unnecessary control information, in order to efficiently transmit an IP packet such as an IPv4 or IPv6 packet in a radio interval having a narrow bandwidth. In addition, in LTE, the PDCP layer also performs a security function, which consists of ciphering for preventing a third party from monitoring data and integrity protection for preventing data manipulation by a third party.

The Radio Resource Control (RRC) layer, which is located at the uppermost part of the third layer, is defined only in the control plane, and serves to configure radio bearers (RBs) and control a logical channel, a transport channel, and a physical channel in relation to reconfiguration and release operations. The RB represents a service provided by the second layer to ensure data transfer between a UE and the E-UTRAN.

If an RRC connection is established between the RRC layer of the UE and the RRC layer of a wireless network, the UE is in the RRC Connected mode. Otherwise, the UE is in the RRC Idle mode.

Hereinafter, description will be given of the RRC state of the UE and an RRC connection method. The RRC state refers to a state in which the RRC of the UE is or is not logically connected with the RRC of the E-UTRAN. The RRC state of the UE having logical connection with the RRC of the E-UTRAN is referred to as an RRC_CONNECTED state. The RRC state of the UE which does not have logical connection with the RRC of the E-UTRAN is referred to as an RRC_IDLE state. A UE in the RRC_CONNECTED state has RRC connection, and thus the E-UTRAN may recognize presence of the UE in a cell unit. Accordingly, the UE may be efficiently controlled. On the other hand, the E-UTRAN cannot recognize presence of a UE which is in the RRC_IDLE state. The UE in the RRC_IDLE state is managed by a core network in a tracking area (TA) which is an area unit larger than the cell. That is, for the UE in the RRC_IDLE state, only presence or absence of the UE is recognized in an area unit larger than the cell. In order for the UE in the RRC_IDLE state to be provided with a usual mobile communication service such as a voice service and a data service, the UE should transition to the RRC_CONNECTED state. A TA is distinguished from another TA by a tracking area identity (TAI) thereof. A UE may configure the TAI through a tracking area code (TAC), which is information broadcast from a cell.

When the user initially turns on the UE, the UE searches for a proper cell first. Then, the UE establishes RRC connection in the cell and registers information thereabout in the core network. Thereafter, the UE stays in the RRC_IDLE state. When necessary, the UE staying in the RRC_IDLE state selects a cell (again) and checks system information or paging information. This operation is called camping on a cell. Only when the UE staying in the RRC_IDLE state needs to establish RRC connection, does the UE establish RRC connection with the RRC layer of the E-UTRAN through the RRC connection procedure and transition to the RRC_CONNECTED state. The UE staying in the RRC_IDLE state needs to establish RRC connection in many cases. For example, the cases may include an attempt of a user to make a phone call, an attempt to transmit data, or transmission of a response message after reception of a paging message from the E-UTRAN.

The non-access stratum (NAS) layer positioned over the RRC layer performs functions such as session management and mobility management.

Hereinafter, the NAS layer shown in FIG. 3 will be described in detail.

The eSM (evolved Session Management) belonging to the NAS layer performs functions such as default bearer management and dedicated bearer management to control a UE to use a PS service from a network. The UE is assigned a default bearer resource by a specific packet data network (PDN) when the UE initially accesses the PDN. In this case, the network allocates an available IP to the UE to allow the UE to use a data service. The network also allocates QoS of a default bearer to the UE. LTE supports two kinds of bearers. One bearer is a bearer having characteristics of ensured bit rate (GBR) QoS for guaranteeing a specific bandwidth for transmission and reception of data, and the other bearer is a non-GBR bearer which has characteristics of best effort QoS without guaranteeing a bandwidth. The default bearer is assigned to a non-GBR bearer. The dedicated bearer may be assigned a bearer having QoS characteristics of GBR or non-GBR.

A bearer allocated to the UE by the network is referred to as an evolved packet service (EPS) bearer. When the EPS bearer is allocated to the UE, the network assigns one identifier (ID). This ID is called an EPS bearer ID. One EPS bearer has QoS characteristics of a maximum bit rate (MBR) and/or a ensured bit rate (GBR).

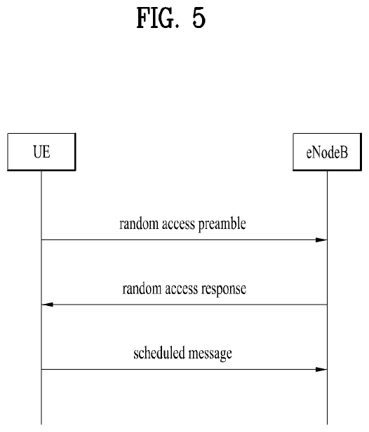

FIG. 5 is a flowchart illustrating a random access procedure in 3GPP LTE.

The random access procedure is used for a UE to obtain UL synchronization with an eNB or to be assigned a UL radio resource.

The UE receives a root index and a physical random access channel (PRACH) configuration index from an eNodeB. Each cell has 64 candidate random access preambles defined by a Zadoff-Chu (ZC) sequence. The root index is a logical index used for the UE to generate 64 candidate random access preambles.

Transmission of a random access preamble is limited to a specific time and frequency resources for each cell. The PRACH configuration index indicates a specific subframe and preamble format in which transmission of the random access preamble is possible.

The UE transmits a randomly selected random access preamble to the eNodeB. The UE selects a random access preamble from among 64 candidate random access preambles and the UE selects a subframe corresponding to the PRACH configuration index. The UE transmits the selected random access preamble in the selected subframe.

Upon receiving the random access preamble, the eNodeB sends a random access response (RAR) to the UE. The RAR is detected in two steps. First, the UE detects a PDCCH masked with a random access (RA)-RNTI. The UE receives an RAR in a MAC (medium access control) PDU (protocol data unit) on a PDSCH indicated by the detected PDCCH.

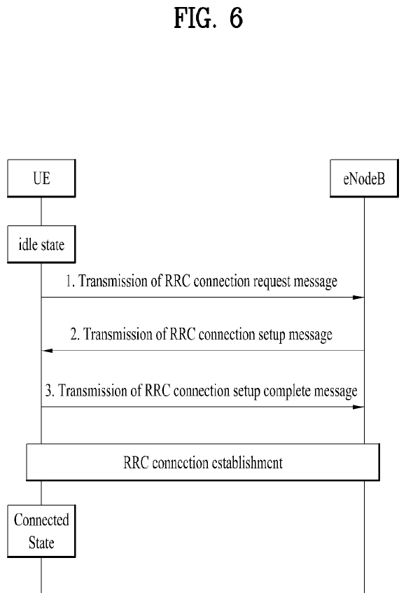

FIG. 6 illustrates a connection procedure in a radio resource control (RRC) layer.

As shown in FIG. 6, the RRC state is set according to whether or not RRC connection is established. An RRC state indicates whether or not an entity of the RRC layer of a UE has logical connection with an entity of the RRC layer of an eNodeB. An RRC state in which the entity of the RRC layer of the UE is logically connected with the entity of the RRC layer of the eNodeB is called an RRC connected state. An RRC state in which the entity of the RRC layer of the UE is not logically connected with the entity of the RRC layer of the eNodeB is called an RRC idle state.

A UE in the Connected state has RRC connection, and thus the E-UTRAN may recognize presence of the UE in a cell unit. Accordingly, the UE may be efficiently controlled. On the other hand, the E-UTRAN cannot recognize presence of a UE which is in the idle state. The UE in the idle state is managed by the core network in a tracking area unit which is an area unit larger than the cell. The tracking area is a unit of a set of cells. That is, for the UE which is in the idle state, only presence or absence of the UE is recognized in a larger area unit. In order for the UE in the idle state to be provided with a usual mobile communication service such as a voice service and a data service, the UE should transition to the connected state.

When the user initially turns on the UE, the UE searches for a proper cell first, and then stays in the idle state. Only when the UE staying in the idle state needs to establish RRC connection, the UE establishes RRC connection with the RRC layer of the eNodeB through the RRC connection procedure and then performs transition to the RRC connected state.

The UE staying in the idle state needs to establish RRC connection in many cases. For example, the cases may include an attempt of a user to make a phone call, an attempt to transmit data, or transmission of a response message after reception of a paging message from the E-UTRAN.

In order for the UE in the idle state to establish RRC connection with the eNodeB, the RRC connection procedure needs to be performed as described above. The RRC connection procedure is broadly divided into transmission of an RRC connection request message from the UE to the eNodeB, transmission of an RRC connection setup message from the eNodeB to the UE, and transmission of an RRC connection setup complete message from the UE to eNodeB, which are described in detail below with reference to FIG. 6.

1) When the UE in the idle state desires to establish RRC connection for reasons such as an attempt to make a call, a data transmission attempt, or a response of the eNodeB to paging, the UE transmits an RRC connection request message to the eNodeB first.

2) Upon receiving the RRC connection request message from the UE, the ENB accepts the RRC connection request of the UE when the radio resources are sufficient, and then transmits an RRC connection setup message, which is a response message, to the UE.

3) Upon receiving the RRC connection setup message, the UE transmits an RRC connection setup complete message to the eNodeB. Only when the UE successfully transmits the RRC connection setup message, does the UE establish RRC connection with the eNode B and transition to the RRC connected mode.

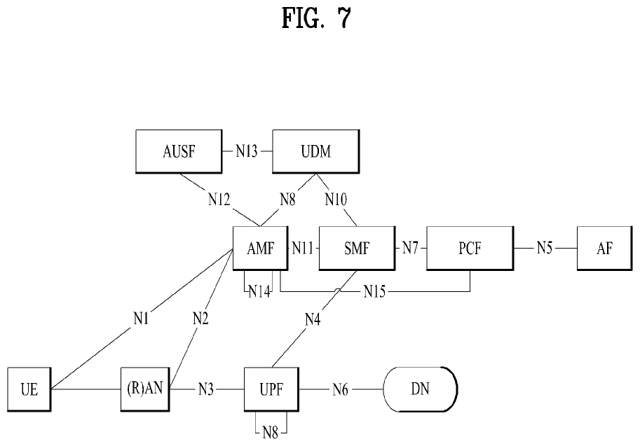

The functionality of the MME in the legacy EPC is decomposed into the access and mobility management function (AMF) and the session management function (SMF) in the next generation system (or 5G core network (CN)). The AMF carries out NAS interaction with a UE and mobility management (MM), whereas the SMF carries out session management (SM). The SMF also manages a gateway, user plane function (UPF), which has the user-plane functionality, that is, routes user traffic. It may be considered that the SMF and the UPF implement the control-plane part and user-plane part of the S-GW and the P-GW of the legacy EPC, respectively. To route user traffic, one or more UPFs may exist between a RAN and a data network (DN). That is, for 5G implementation, the legacy EPC may have the configuration illustrated in FIG. 7. In the 5G system, a protocol data unit (PDU) session has been defined as a counterpart to a PDN connection of the legacy EPS. A PDU session refers to association between a UE and a DN, which provides a PDU connectivity service of an Ethernet type or an unstructured type as well as an IP type. The unified data management (UDM) performs the same functionality as the HSS of the EPC, and the policy control function (PCF) performs the same functionality as the policy and charging rules function (PCRF) of the EPC. Obviously, the functionalities may be extended to satisfy the requirements of the 5G system. For details of the architecture, functions, and interfaces of a 5G system, TS 23.501 is conformed to.

The 5G system is being worked on in TS 23.501 and TS 23.502. Accordingly, the technical specifications are conformed to for the 5G system in the present disclosure. Further, TS 38.300 is conformed to for details of NG-RAN-related architecture and contents. As the 5G system also supports non-3GPP access, Section 4.2.8 of TS 23.501 describes architecture and network elements for supporting non-3GPP access, and Section 4.12 of TS 23.502 describes procedures for supporting non-3GPP access. A representative example of non-3GPP access is WLAN access, which may include both a trusted WLAN and an untrusted WLAN. The AMF of the 5G system performs registration management (RM) and connection management (CM) for non-3GPP access as well as 3GPP access. As such, the same AMF serves a UE for 3GPP access and non-3GPP access belonging to the same PLMN, so that one network function may integrally and efficiently support authentication, mobility management, and session management for UEs registered through two different accesses.

In 3GPP, architecture enhancements studies for advanced V2X with a scope shown in Table 2 below are in progress (see 3GPP SP-170590). The content of these studies is described in TR 23.786.

TABLE 2
The objectives of this study are to identify and evaluate potential architecture
enhancements of EPS and 5G System design needed to support advanced V2X services
identified in TR 22.886, based on vehicular services requirements defined in SA1 V2X
(TS 22.185) and eV2X (TS 22.186) and determine which of the solutions may proceed to
normative specifications.
The detailed objectives are as follows:

| | |
|---|---|
| 1. | Investigate and evaluate the possible reuse/enhancement of existing functionalities and |

architectures (e.g. NR, E-UTRA, NG-RAN, E-UTRAN, 5G CN, EPC) in order to support
advanced V2X services, including but not limited to:

| | |
|---|---|
| - | platooning, extended sensor sharing, ranging to enhance positioning accuracy and other network |

based positioning enhancements, advanced driving, and remote driving.

| | |
|---|---|
| 2. | Identify which of the solutions for architecture enhancements could proceed to normative |

specifications.

The timely completion of the EPS part of the study by September, 2017 is targeted,
aiming at allowing normative work in Rel-15 timeframe.
This study will align with the 5GS Phase 1 normative work. The 5G System support for
V2X will also depend on features that need to be studied in other 5GS study items.
Architectural implications for RAN will be coordinated with RAN WGs.

In addition, studies to improve the service handling of advanced V2X with a scope shown in Table 3 below are in progress (see 3GPP SP-180247). The content of these studies is described in TR 22.886.

TABLE 3
The aim of this work is to study use cases and to derive corresponding potential service
requirements for the 5G System in order to:

| | |
|---|---|
| - | Enable V2X service providers (e.g. OEMs, road authorities) to control V2X services |
| | reliably |
| - | Provide V2X services means to adjust their V2X applications in advance of changes |
| | in quality of service (e.g. by providing notifications) to enable a reliable continuous |
| | operation from a user perspective. |

```
During the study, aspects related to service exposure to V2X service providers and
assistance to the application layer will be addressed.
  Corresponding requirements from external organizations (e.g. ETSI ITS, SAE, 5GAA)
  pertaining to the above will be considered.
```

In addition, studies on enablers for Network Automation with a scope shown in Table 4 below are in progress (refer to 3GPP SP-180613). This is a study to enhance the NWDA defined in Rel-15 5GS, and the contents of the study are described in TR 23.791.

TABLE 4
Operators have traditionally been collecting information about their network and more
and more such collected information is being mined. Network Data Analytics (NWDA) is
introduced in the 5G phase1 to automatically provide slice specific network data analytics
to the network.
In Rel15, NWDA only notifies or publishes slice specific network status analytic
information to the PCF(s) that are subscribed to it. However, other network functions may
also benefit from NWDA reporting.
In order to improve the NWDA work initiated in Rel15, it looks beneficial to further
investigate solutions for supporting network automation deployment .with information
exposure across technical domains for context mining .The work will study the
necessary data to expose to NWDA and the necessary NWDA outputs in order to at least
support (non-exhaustive list):

| - | Customized mobility management per UE e.g. paging enhancements and mobility pattern |
|---|---|
| - 5G QoS enhancement e.g. 5G QoS target fulfilment verification and QoS profile for non- | |
| | standardized 5QI |
| - | Dynamic traffic steering and splitting, UPF selection, UE traffic routing policies based on |
| | UE's service usage behaviour |
| - | Service classification based resource management e.g. background data transfer for MNO and |

3rd party service provider and TV content

No algorithms or NWDA internal behaviour is to be specified, which is out of the scope
of 3GPP and the SID will focus on how to collect data and how to feedback network data
analytics to the network.
During the study phase, other SDOs/organizations (as appropriate) may need to be
consulted to ensure and evaluate the performance applicability and any solutions
implications and any overlapping on their areas.

The NWDA and NWDAF defined in Rel-15 refer to TS 23.501 Section 4.2.9 (Network Analytics architecture), and TS 23.501 Section 6.2.18 (Network Data Analytics Function (NWDAF)), TS 23.502 Section 4.19 (Network Data Analytics), TS 23.502 Section 5.2.11 (NWDAF Services), and NWDA and NWDAF of TS 23.503. Further, information on 5GS (5G System) refer to TS 23.501, TS 23.502, TS 23.503, and the like.

Further, Section 5.27 of TR 22.886v16.0.0 describes QoS aspects of advanced driving. In particular, Section 5.27.7 thereof describes scenarios and requirements to support reliable and ensured network connectivity for automated driving as follows. Further, Section 5.28 of TR 22.886v16.0.0 describes QoS aspects of remote driving. In the remote driving, a remote driver not boarding on a vehicle UE drives the vehicle UE through the network, and thus, it is also important to ensure the network connectivity. Therefore, as described in QoS aspect of remote driving of Section 5.28 of TR 22.886v16.0.0, scenarios and requirements to support the ensured network connectivity are described.

As the UE moves, NG-RAN, UPF, etc. that provide the network connectivity to the UE may change. However, it is necessary to continuously provide reliable and ensured network connectivity to the UE despite this change. This may mean that the UE must continuously guarantee the QoS required by an application (e.g., automatic driving, remote driving, etc.) as being executed.

However, in the prior art, as the UE moves, a target NG-RAN may not receive all QoS flows upon handover. Accordingly, some QoS flows of a PDU session or all QoS flows of the PDU session may not be allowed in the target NG-RAN, such that the handover may not be performed. (The handover procedure refers to the contents defined in TS 23.502.) A reason that the target NG-RAN does not accept all QoS flows during the handover may be due to admission control. (Refer to TS 38.300)

The UE (or the application being executed on the UE, PDU session, flow, etc.) continuously requires reliable and ensured network connectivity. As described above, when the PDU session or flow that requires such a continuous connection may not move to the target NG-RAN during the handover, this may cause a problem in UE operation. For example, in the automatic driving or remote driving, when the connectivity is not ensured, the driving may not be performed properly.

Therefore, in following various embodiments of the present disclosure, methods for ensuring reliable and ensured network connectivity for the above UE (or applications being executed on the UE, PDU session, flow, etc.) will be described.

### Embodiments

According to an embodiment of the present disclosure, the NF (AMF, or SMF, PCF, UDM, AF, NWDAF) may select at least one NG-RAN on an moving path of the UE. That is, the NF may select not only Serving NG-RAN but also at least one resource reservation candidate NG-RAN for resource reservation on the UE's moving path for a specific flow or PDU session of the UE (Flow/PDU session requiring reliable and continuous network connectivity, hereinafter referred to as ensured-connectivity requiring Flow/PDU session).

QoS Reservation Profile may be provided to the selected at least one NG-RAN. That is, when the QoS Profile is provided to the serving NG-RAN of the UE, a QoS Profile (QoS Reservation Profile) related to the resource reservation is provided to the resource reservation candidate NG-RAN. In this connection, the QoS reservation profile may include at least one of information about the UE, information about the Flow/PDU session for which resource reservation is required, information related to the required QoS, a resource reservation start timing, and a resource reservation termination timing.

The QoS Reservation Profile is intended for the specific Flow or PDU session, and is configured to request resource reservation for the Flow/PDU session toward the resource reservation candidate NG-RAN. That is, the QoS reservation profile allows the at least one NG-RAN to perform resource reservation for a Flow/PDU session. When the resource reservation candidate NG-RAN receives the QoS Reservation Profile from the core network, the resource reservation candidate NG-RAN performs resource reservation for the Flow/PDU session for which a resource should be reserved. This may be interpreted as guaranteeing the QoS required during a time when the resource reservation should be made. This may be interpreted as that when the NG-RAN performs admission control, the Flow/PDU session has not yet been activated, but is regarded as activated and thus the admission control is performed. This may be interpreted as ensuring the QoS as required when a user plane of the Flow/PDU session is activated. This may be interpreted as that the resource reservation candidate NG-RAN should guarantee the QoS required for the Flow/PDU session when serving the UE.

Further, a handover for a Flow/PDU session to at least one NG-RAN that has performed the resource reservation may always be allowed. That is, when the target NG-RAN of the handover receives QoS Reservation Profile related information and makes resource reservation for a resource ensured Flow/PDU session, the handover may be unconditionally allowed for this Flow/PDU session. This may be interpreted as not performing the admission control for the corresponding Flow/PDU session. Further, when performing the handover for the Flow/PDU session, the target NG-RAN may determine a next target NG-RAN.

As mentioned above, the QoS reservation profile includes at least one of the information about the UE, the information about the Flow/PDU session for which the resource reservation is required, the information related to the required QoS, the resource reservation start timing (immediately starting time, or in a few seconds, etc.; the resource reservation start timing may be expressed in various ways) and the resource reservation termination timing. Those information may be delivered explicitly or implicitly. A portion of the information may be included in the QoS Reservation Profile, and another portion thereof may be included in N2 SM information including the QoS Reservation Profile, and still another portion thereof may be included in a NGAP message including the N2 SM information. Therefore, those information may be referred to as QoS Reservation Profile related information. Information on the flow/PDU session for which the resource reservation is required and the required QoS-related information may be consistent with contents included in the QoS Profile, or may extend to include information required for the resource reservation. In more detail, this information may include one or more of i) One or multiple QoS profiles and the corresponding QFIs, ii) PDU session ID, and iii) S-NSSAI and/or DNN. In addition, the QoS Profile information refer to TS 23.501, TS 23.502, TS 38.413, etc. In the above standards, in addition to the QoS Profile, messages and parameters transmitted from the SMF/AMF to the NG-RAN in relation to the Flow/PDU session may be referenced.

The resource reservation start timing and/or termination timing may be set for each NG-RAN. That is, when there are a plurality of resource reservation candidate NG-RANs, different timings may be set for the different resource reservation candidate NG-RANs. For example, the serving NG-RAN of the UE is NG-RAN #1, and then as the UE moves, the UE receives serving from NG-RAN #2, and, thereafter, when the UE receives serving from NG-RAN #3. In this case, the resource reservation start timing provided to NG-RAN #2 may be earlier than the resource reservation start timing provided to NG-RAN #3. The resource reservation may be performed for a time duration between the resource reservation start time and the resource reservation end time.

In one example, the resource reservation candidate NG-RAN may be i) an NG-RAN expected to serve a UE, or ii) an NG-RAN capable of resource reservation. The NG-RAN may be determined based on network configuration information, region information, UE moving path and speed, network congestion level, and the like. Further, the at least one NG-RAN may be selected when a PDU session is created, when the UE is in a connected mode, when a user plane of a PDU session is activated, when a PDU session is modified, when a UE is registered, or when a handover is performed. That is, the resource reservation candidate NG-RAN(s) may be selected upon handover, or may be pre-selected. The pre-selection time may be various times, for example, when a PDU session is created, when the UE is in a connected mode, when a user plane of the corresponding PDU session is activated, when a PDU session is modified, or when a UE is registered.

In one example, the QoS reservation profile may be provided to the selected at least one NG-RAN when a PDU session is created. Alternatively, the QoS reservation profile may be provided to the selected at least one NG-RAN when the AMF provides the QoS Profile to the serving NG-RAN of the UE.

Further, whether a specific Flow/PDU session is a ensured-connectivity requiring Flow/PDU session may be determined based on various information provided from the core network, for example, information provided from the UE, subscriber information, network configuration information, DNN information, 5QI information, slicing related information, and information provided from other NFs. When the PDU session is a ensured-connectivity requiring PDU session, this may be interpreted that all flows constituting the PDU session are ensured-connectivity requiring flows.

Further, providing the QoS Profile to the serving NG-RAN of the UE and providing the QoS Reservation Profile to the resource reservation candidate NG-RAN may be performed in the same procedure, or may be performed in different procedures. When both are performed in the same procedure, both may be performed in a parallel manner or may be performed in a sequential manner. The AMF and/or SMF may store information about resource reservation candidate NG-RAN(s) that provides QoS Reservation Profile related information. In this connection, a portion or an entirety of information related to the QoS Reservation Profile as provided may be stored together.

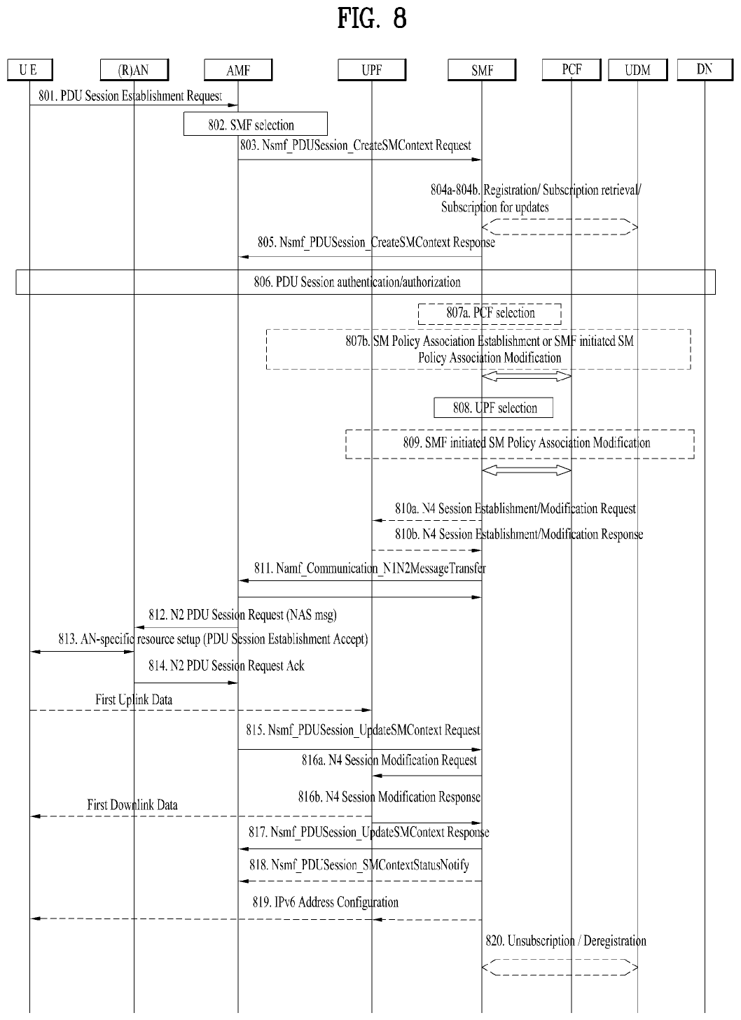

Hereinafter, based on the above description, and referring to FIG. 8 to FIG. 13, canceling a resource reservation when creating a connection-ensured PDU session, during the handover, when modifying a PDU session, when activating a user plane of a PDU session will be described in detail.

FIG. 8 shows an example of an operation when creating a PDU session.

When a PDU session for an ensured-connectivity requiring Flow/PDU session is created, the resource reservation candidate NG-RAN(s) described in the above description is selected, and thus QoS Reservation Profile related information is provided. Major operations will be described based on Section 4.3.2.2.1 of TS 23.502 (Non-roaming and Roaming with Local Breakout) as follows. Since contents proposed/added in the present disclosure will be described mainly, each of steps that are not described below may be replaced with descriptions in 4.3.2.2.1 of TS 23.502. It should be understood that the following is applied to other PDU session creation procedures of TS 23.502.

In step S8011, the SMF provides QoS Reservation Profile related information to the AMF.

In step S8012, a following operation may be performed in parallel with S8012 or at any time after step S8012. However, transmission to the resource reservation candidate NG-RAN as described later may be performed before step S8012. The AMF transmits a message providing QoS Reservation Profile related information to the resource reservation NG-RAN(s). This message may be an extension of a conventional NGAP message or may be a newly defined NGAP message. This message is a message generated based on the QoS Reservation Profile related information provided from the SMF in step S8011. At least a portion of contents of QoS Reservation Profile related information as described in the above description may be provided from SMF, or a portion thereof may be provided from SMF, and AMF may include the other portion thereof into the message. The resource reservation candidate NG-RAN(s) may be determined by AMF, or may be provided from SMF in step S8011. (For reference, the interaction with the resource reservation candidate NG-RAN(s) and AMF is not shown in FIG. 8.)

In step S8012, a resource reservation candidate NG-RAN(s) list or information about NG-RAN that will be a next serving NG-RAN of the UE may be provided to the serving NG-RAN of the UE. Thus, the serving NG-RAN may refer to the provided resource reservation candidate NG-RAN information when determining a target NG-RAN to which the UE will handover.

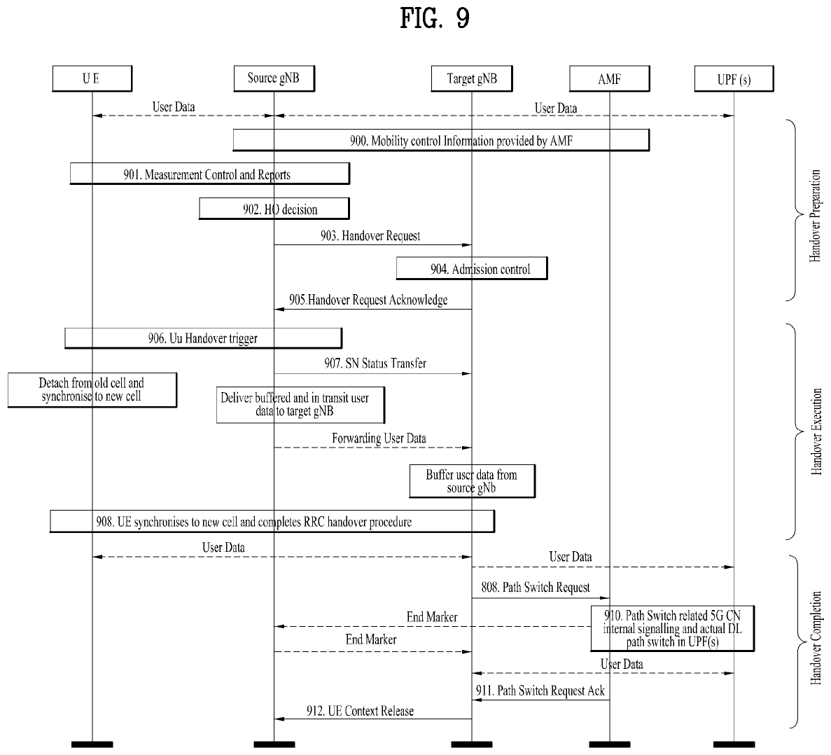

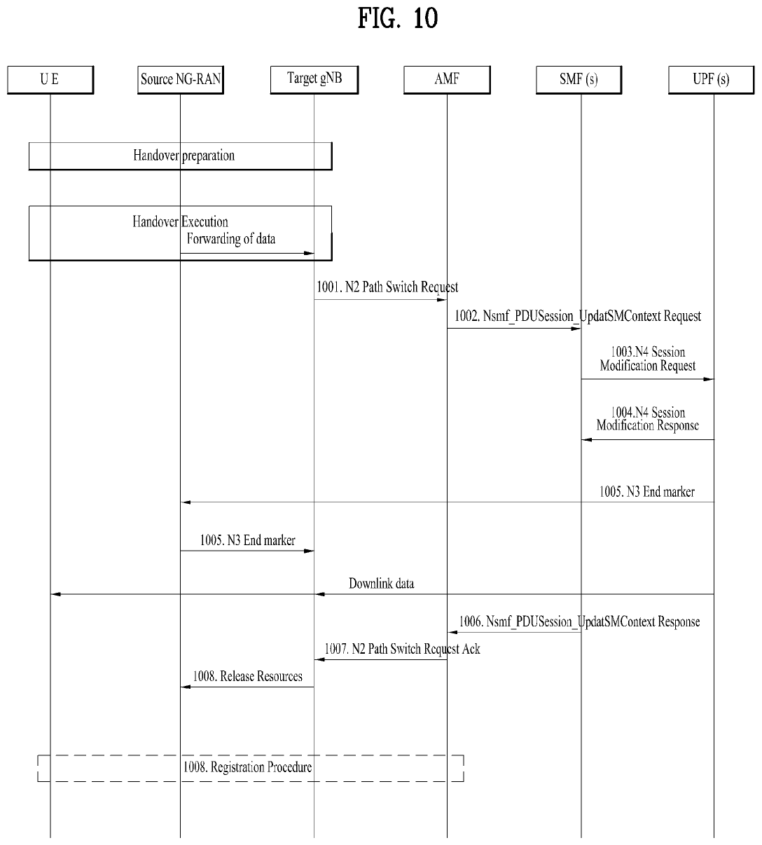

FIG. 9 to FIG. 10 show examples of operations during the handover. Major operations refer to the description in Section 9.2.3.2.1 (C-Plane Handling) of TS 38.300. In step S904, the target NG-RAN has received QoS Reservation Profile related information, and has performed resource reservation for the ensured-connectivity requiring Flow/PDU session according to the present disclosure. Therefore, admission control may not be performed for this Flow/PDU session. Thus, when performing the handover, the UE may receive continuous network connectivity in a form in which QoS is ensured for a resource ensured Flow/PDU session.

In one example, during the handover for the ensured-connectivity requiring Flow/PDU session, QoS Reservation Profile related information is provided to resource reservation candidate NG-RAN(s). Although the resource reservation candidate NG-RAN(s) has not yet provided the QoS Reservation Profile related information, the resource reservation candidate NG-RAN(s) becomes a resource reservation candidate NG-RAN due to the movement of the UE. The resource reservation candidate NG-RAN(s) may be selected upon handover, or may be preselected. The pre-selection timing may be various timings such as when a PDU session is created, when the UE is in a connected mode, when a user plane of the corresponding PDU session is activated, when a PDU session is modified, when a UE is registered. For example, it may be assumed that NG-RAN #1 is the serving NG-RAN of the UE, and as described above, NG-RAN #2 has been selected as a resource reservation candidate NG-RAN and has received QoS Reservation Profile related information when creating a PDU session. Thereafter, when the UE handovers from NG-RAN #1 to NG-RAN #2, NG-RAN #3 which will subsequently serve the UE according to the UE's movement becomes a resource reservation candidate NG-RAN and receives QoS Reservation Profile related information.

In this regard, major operations will be described based on Section 4.9.1.2.2 of TS 23.502 (Xn based inter NG-RAN handover without User Plane function re-allocation) as follows. Following descriptions will focus on suggestions/additions in the present disclosure. It should be understood that following contents applies to other handover procedures in TS 23.502.

Referring to FIG. 10, in step S1006, the SMF provides QoS Reservation Profile related information to the AMF.

In step S1007, a following operation may be performed in parallel with step S1006 or at any time after step S1006. However, transmission to the resource reservation candidate NG-RAN as described later may be performed before step S1006.

The AMF transmits a message providing QoS Reservation Profile related information to the resource reservation NG-RAN(s). This message may be an extension of a conventional NGAP message or may be a newly defined NGAP message. This message is a message generated based on the QoS Reservation Profile related information provided from the SMF in step S1006. At least a portion of contents of QoS Reservation Profile related information as described in the above description may be provided from SMF, or a portion thereof may be provided from SMF, and AMF may include the other portion thereof into the message. The resource reservation candidate NG-RAN(s) may be determined by AMF, or may be provided from SMF in step S1006. (For reference, the interaction with the resource reservation candidate NG-RAN(s) and AMF is not shown in FIG. 10.)

In step S1007, a resource reservation candidate NG-RAN(s) list or information about NG-RAN that will be a next serving NG-RAN of the UE may be provided to the target NG-RAN of the UE. Thus, when the UE should subsequently handover to the target NG-RAN, the target NG-RAN may be determined based on the provided resource reservation candidate NG-RAN information.

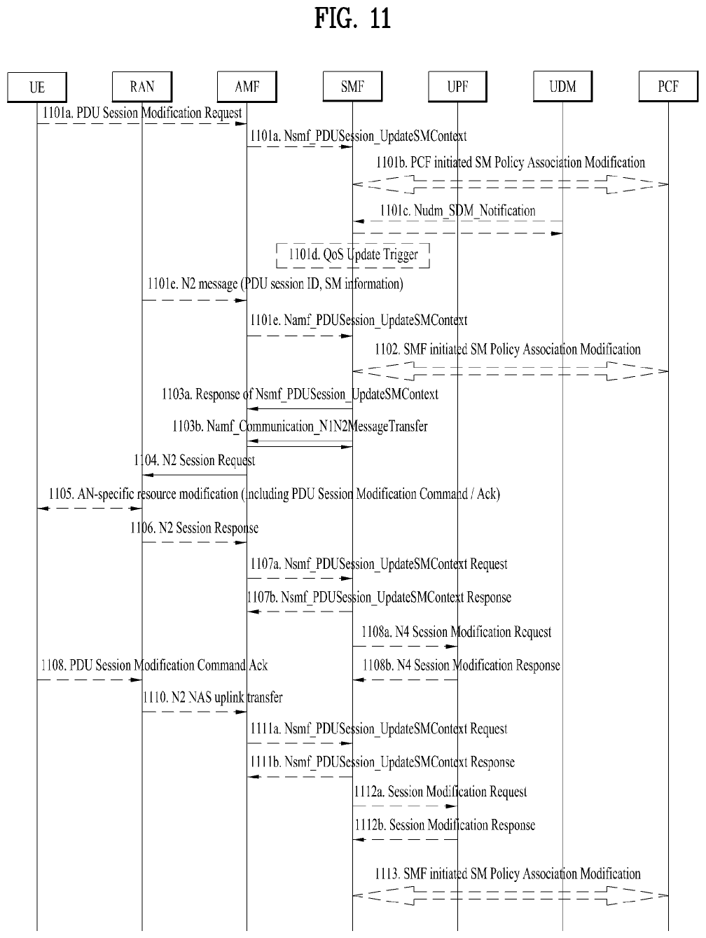

FIG. 11 shows an example of an operation when modifying a PDU session. When the PDU session for the ensured-connectivity requiring Flow/PDU session is modified, QoS Reservation Profile related information is provided to resource reservation candidate NG-RAN(s). This operation is to provide QoS Reservation Profile related information to the resource reservation candidate NG-RAN(s) when a PDU session modification occurs to add a ensured-connectivity requiring flow when the ensured-connectivity requiring flow is otherwise absent. The resource reservation candidate NG-RAN(s) may be selected when modifying a PDU session, or may be pre-selected. The pre-selection timing may be various timings, such as when a PDU session is created, when a UE is in a connected mode, when a user plane of a corresponding PDU session is activated, or when a UE is registered. In this regard, major operations may be described based on Section 4.3.3.2 of TS 23.502 (UE or network requested PDU session Modification (non-roaming and roaming with local breakout)) as follows. Following descriptions will focus on suggestions/additions in the present disclosure. It should be understood that following contents are applied to other PDU session modification procedures of TS 23.502.

In step S1103a or step S1103b, the SMF provides QoS Reservation Profile related information to the AMF.

A following operation may be performed in parallel with step S1104 or at any time after step S1104. However, transmission to the resource reservation candidate NG-RAN as described later may be performed before step S1104.

AMF transmits a message providing QoS Reservation Profile related information to resource reservation candidate NG-RAN(s). This message may be an extension of a conventional NGAP message or may be a newly defined NGAP message. This message is a message generated based on the QoS Reservation Profile related information provided from the SMF in step S1103a or S1103b. At least a portion of contents of QoS Reservation Profile related information as described in the above description may be provided from SMF, or a portion thereof may be provided from SMF, and AMF may include the other portion thereof into the message.

The resource reservation candidate NG-RAN(s) may be determined by AMF, or may be provided from SMF in step S1103a or step S1103b. (For reference, the interaction with the resource reservation candidate NG-RAN(s) and AMF is not shown in FIG. 11.)

In step S1104, a resource reservation candidate NG-RAN(s) list or information about NG-RAN that will be a next serving NG-RAN of the UE may be provided to the serving NG-RAN of the UE. Thus, the serving NG-RAN may refer to the provided resource reservation candidate NG-RAN information when determining the target NG-RAN to which the UE handovers.

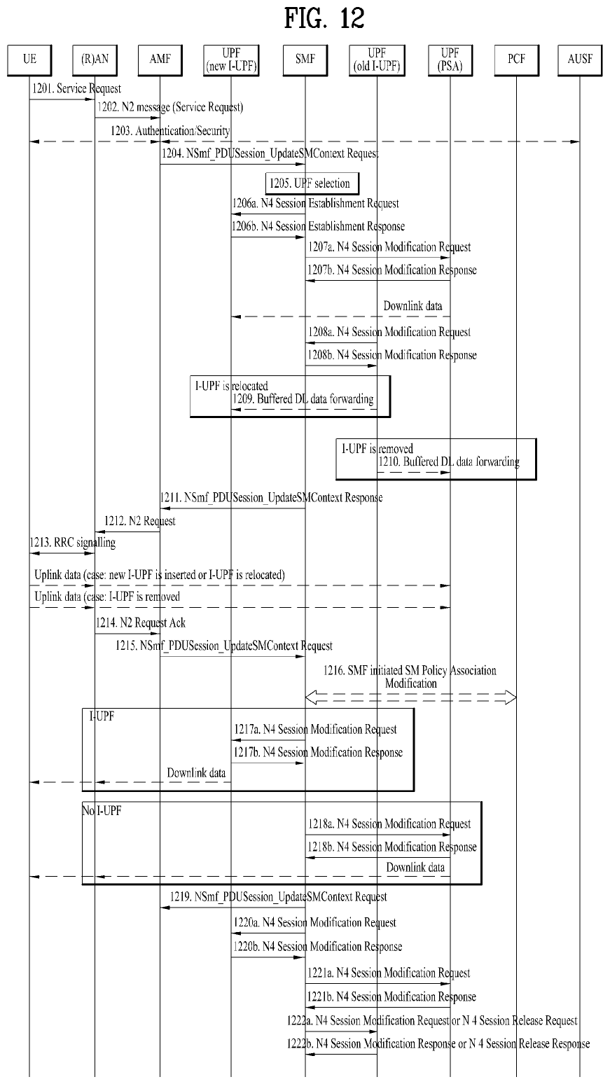

FIG. 12 shows an example of an operation during user plane activation of a PDU session.

The user plane of the PDU session may be activated by including information (List Of PDU sessions To Be Activated) for re-activating the PDU session during the registration procedure. Alternatively, the user plane of the PDU session may be activated via the Service Request procedure. A following operation may be performed when the user plane of the ensured-connectivity requiring Flow/PDU session is activated, for example, during the above procedure. The QoS Reservation Profile related information may be provided to resource reservation candidate NG-RAN(s). The resource reservation candidate NG-RAN(s) may be selected upon user plane activation of a PDU session, or may be pre-selected. The pre-selection timing may be various time points such as when a PDU session is created, when a PDU session is modified, when a UE is in a connected mode, or when a UE is registered.

Major operations are described based on Section 4.2.3.2 (UE Triggered Service Request) of TS 23.502 as follows. Following descriptions will focus on suggestions/additions in the present disclosure. It should be understood that following contents applies to all of procedures in which the user plane of the Flow/PDU session is activated, for example, to the registration procedure of TS 23.502.

In step S1211, the SMF provides QoS Reservation Profile related information to the AMF.

A following operation may be performed in parallel with step S1212 or at any time after step S1212. However, transmission to the resource reservation candidate NG-RAN as described below may be performed before step S1212.

AMF transmits a message providing QoS Reservation Profile related information to resource reservation candidate NG-RAN(s). This message may be an extension of a conventional NGAP message or may be a newly defined NGAP message. This message is a message generated based on the QoS Reservation Profile related information provided from the SMF in step S1211. At least a portion of contents of QoS Reservation Profile related information as described in the above description may be provided from SMF, or a portion thereof may be provided from SMF, and AMF may include the other portion thereof into the message.

The resource reservation candidate NG-RAN(s) may be determined by AMF, or may be provided from SMF in step S1211. (For reference, the interaction with the resource reservation candidate NG-RAN(s) and AMF is not shown in FIG. 12.)

In step S1212, a resource reservation candidate NG-RAN(s) list or information about NG-RAN that will be a next serving NG-RAN of the UE may be provided to the serving NG-RAN of the UE. Thus, the serving NG-RAN may refer to the provided resource reservation candidate NG-RAN information when determining the target NG-RAN to which the UE handovers.

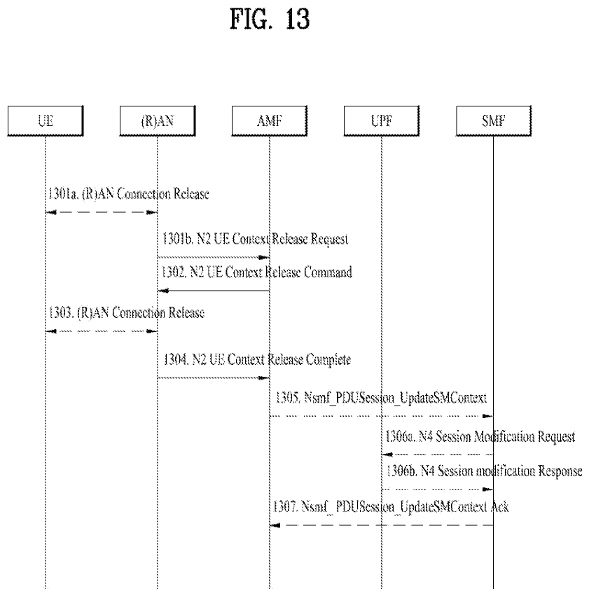

FIG. 13 shows an example of an operation of canceling the resource reservation.

After providing the QoS Reservation Profile to the resource reservation candidate NG-RAN, the core network may perform an operation of canceling or revoking the resource reservation. This is the case when it is determined/identified that resource reservation is no longer required for the ensured-connectivity requiring Flow/PDU session. Typically, this is the case when the UE switches to an idle mode, when the PDU session is deactivated, when the resource guarantee flow is removed from the PDU session (and thus the PDU session is modified). Further, in addition to the above cases, when it is determined that resource reservation is no longer needed for the ensured-connectivity requiring Flow/PDU session, the resource reservation cancellation may be performed.

When major operations are described based on Section 4.2.6 (AN Release) of TS 23.502 as follows. Following descriptions will focus on suggestions/additions in the present disclosure. It should be understood that following contents may be applied to a case when it is determined that resource reservation cancellation is necessary as described above, for example, to the PDU session deactivation procedure and PDU session modification procedure of TS 23.502.

A following operation may be performed in parallel with step S1302 or at any time after step S1302. However, transmission to the resource reservation candidate NG-RAN as described below may be performed before step S1302. AMF transmits a message to cancel resource reservation to resource reservation candidate NG-RAN(s) that has provided the QoS Reservation Profile related information. This message may be an extension of a conventional NGAP message or may be a newly defined NGAP message. When the AMF and/or SMF has stored the information on the resource reservation candidate NG-RAN(s) therein, the AMF and/or SMF deletes the information.

Alternatively, unlike the above manner, the resource reservation candidate NG-RAN may perform the resource reservation cancellation by itself. In this connection, the resource reservation termination timing has been included in the QoS Reservation Profile related information ((d) information in the above description). When the UE is not connected to the NG-RAN by resource reservation termination timing, that is, when the NG-RAN does not act as the serving NG-RAN, the resource reservation is canceled or revoked.

The above description has mainly focused on reserving the resource in NG-RAN. However, the above description may be extended and applied to a case when the UPF for the specific Flow/PDU session, particularly the N3 UPF changes as the UE moves.

The method for efficiently supporting the network connectivity via the 3GPP 5G System (5G mobile communication system, next-generation mobile communication system) as proposed in the present disclosure may be used for various services, but is particularly useful for V2X service. However, the application of the method is not limited to the V2X service. In accordance with the present disclosure, V2X service is used interchangeably with V2X application, V2X message, V2X traffic, and V2X data. With regard to the V2X service, the UE may include all various UEs such as vehicle UEs as well as pedestrian UEs.

Overview of Devices to Which the Present Disclosure is Applicable

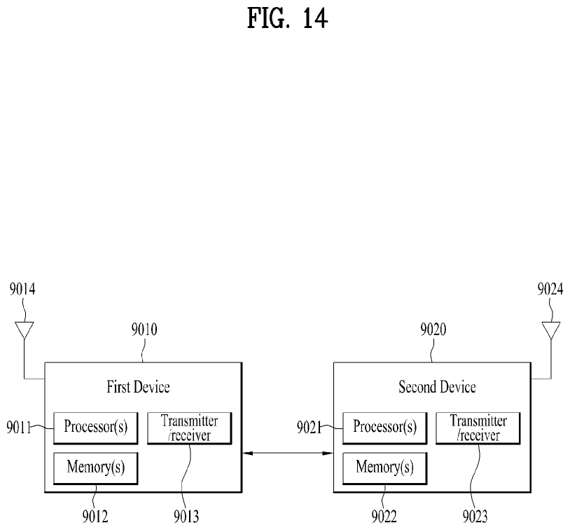

Now, a description will be given of devices to which the present disclosure is applicable. FIG. 14 is a block diagram illustrating wireless communication devices according to an embodiment of the present disclosure.

Referring to FIG. 14, a wireless communication system may include a first device 9010 and a second device 9020.

The first device 9010 may be any of a base station, a network node, a transmitting UE, a receiving UE, a wireless device, a wireless communication device, a vehicle, a vehicle equipped with a self-driving function, a connected car, an unmanned aerial vehicle (UAV), an artificial intelligence (AI) module, a robot, an AR device, a VR device, a mixed reality (MR) device, a hologram device, a public safety device, an MTC device, an IoT device, a medical device, a FinTech device (or financial device), a security device, a weather/environmental device, a 5G service-related device, and a device related to a 4th industrial revolution field.

The second device 9020 may be any of a base station, a network node, a transmitting UE, a receiving UE, a wireless device, a wireless communication device, a vehicle, a vehicle equipped with a self-driving function, a connected car, an UAV, an AI module, a robot, an AR device, a VR device, an MR device, a hologram device, a public safety device, an MTC device, an IoT device, a medical device, a FinTech device (or financial device), a security device, a weather/environmental device, a 5G service-related device, and a device related to a 4th industrial revolution field.

The UE may be any of, for example, a portable phone, a smart phone, a laptop computer, a digital broadcasting terminal, a personal digital assistant (PDA), a portable multimedia player (PMP), a navigation device, a slate PC, a tablet PC, an ultrabook, and a wearable device (e.g., a smart watch, smart glasses, or a head mounted display (HMD)). The HMD may be, for example, a display device which may be worn around the head. For example, the HMD may be used for VR, AR, or MR.

The UAV may be, for example, an unmanned aircraft which flies by a wireless control signal. The VR device may include, for example, a device that renders objects or a background of a virtual world. The AR device may include, for example, a device which connects an object or background in a virtual world to an object or background in a real world. The MR device may include, for example, a device which merges an object or background in a virtual world with an object or background in a real world. The hologram device may include, for example, a device which renders 306-degree stereoscopic images by recording and reproducing stereoscopic information, relying on light interference occurring when two laser beams meet. The public safety device includes, for example, a relay device or device wearable on a user's body. The MTC device and the IoT device may include, for example, a device which does not require human intervention or manipulation. For example, the MTC device and the IoT device may include a smart meter, a vending machine, a thermometer, a smart bulb, a door lock, or various sensors. The medical device may include, for example, a device used for diagnosis, treatment, relief, or prevention of diseases. For example, the medical device may be a device used for the purpose of diagnosing, treating, relieving, or correcting injury or impairment. For example, the medical device may be a device used for the purpose of examining, replacing, or modifying a structure or a function. For example, the medical device may be a device for controlling pregnancy. For example, the medical device may include a device for treatment, a surgery device, an (in vitro) diagnosis device, or a hearing aid. The security device may be, for example, a device installed to avoid danger and maintain safety. For example, the security device may be a camera, a closed-circuit television (CCTV), a recorder, or a black box. The FinTech device may be, for example, a device which may provide a financial service such as mobile payment. For example, the FinTech device may include a payment device or a point of sales (PoS) terminal. The weather/environmental device may be, for example, a device which monitors or predicts weather/an environment.

The first device 9010 may include at least one processor such as a processor 9011, at least one memory such as a memory 9012, and at least one transmitter/receiver such as a transmitter/receiver 9013. The processor 9011 may perform the afore-described functions, procedures, and/or methods. The processor 9011 may implement one or more protocols. For example, the processor 9011 may implement one or more of radio interface protocols. The memory 9012 may be coupled to the processor 9011 and store various types of information and/or commands. The transmitter/receiver 9013 may be coupled to the processor 9011 and controlled to transmit and receive radio signals.

Specifically, the at least one processor of the first device may processor is configured to select at least one next generation radio access network (NG-RAN) on a moving path of a user equipment (UE) and provide a QoS reservation profile to the selected at least one NG-RAN, wherein the QoS reservation profile includes at least one of information on the UE, information on a Flow/PDU session for which resource reservation is required, information on required QoS, a resource reservation start timing, and a resource reservation termination timing.

The second device 9020 may include at least one processor such as a processor 9021, at least one memory such as a memory 9022, and at least one transmitter/receiver such as a transmitter/receiver 9023. The processor 9021 may perform the afore-described functions, procedures, and/or methods. The processor 9021 may implement one or more protocols. For example, the processor 9021 may implement one or more of radio interface protocols. The memory 9022 may be coupled to the processor 9021 and store various types of information and/or commands. The transmitter/receiver 9023 may be coupled to the processor 9021 and controlled to transmit and receive radio signals.

The memory 9012 and/or the memory 9022 may be coupled to the processor 9011 and/or the processor 9021 inside or outside the processor 9011 and/or the processor 9021, or to another processor by various techniques such as wired connection or wireless connection.

The first device 9010 and/or the second device 9020 may include one or more antennas. For example, an antenna 9014 and/or an antenna 9024 may be configured to transmit and receive radio signals.

The specific configurations of the first device 9010 and the second device 9020 may be implemented such that the details described in the various embodiments of the present disclosure may be applied independently or implemented such that two or more of the embodiments are applied at the same time. For clarity, a redundant description is omitted.

The embodiments of the present disclosure may be implemented through various means, for example, hardware, firmware, software, or a combination thereof.

In a hardware configuration, the embodiments of the present disclosure may be achieved by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, a method according to embodiments of the present disclosure may be implemented in the form of a module, a procedure, a function, etc. Software code may be stored in a memory unit and executed by a processor. The memory unit is located at the interior or exterior of the processor and may transmit and receive data to and from the processor via various known means.

As described before, a detailed description has been given of preferred embodiments of the present disclosure so that those skilled in the art may implement and perform the present disclosure. While reference has been made above to the preferred embodiments of the present disclosure, those skilled in the art will understand that various modifications and alterations may be made to the present disclosure within the scope of the present disclosure. For example, those skilled in the art may use the components described in the foregoing embodiments in combination. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

While various embodiments of the present disclosure have been described in the context of a 3GPP system, the embodiments are applicable in the same manner to various mobile communication systems.

What is claimed is:

1. A method for transmitting and receiving, by an access and mobility management function (AMF), a signal to ensure connectivity in a wireless communication system, the method comprising:
selecting, the AMF, at least one next generation radio access network (NG-RAN) on a moving path of a user equipment (UE); and
providing, by the AMF, a QoS reservation profile to the selected at least one NG-RAN,
wherein the QoS reservation profile includes at least one of information on the UE, information on a Flow/PDU session for which resource reservation is required, information on required QoS, a resource reservation start timing, and a resource reservation termination timing.

2. The method of claim 1, wherein the QoS reservation profile is configured to allow the at least one NG-RAN to perform resource reservation for a Flow/PDU session.

3. The method of claim 2, wherein handover to the at least one NG-RAN that has performed the resource reservation for a Flow/PDU session is always allowed.

4. The method of claim 3, wherein when performing the handover for the Flow/PDU session, a target NG-RAN determines a next target NG-RAN.

5. The method of claim 2, wherein the resource reservation is performed for a time duration between the resource reservation start timing and the resource reservation termination timing.

6. The method of claim 2, wherein each of the resource reservation start timing and the resource reservation termination timing is set for each NG-RAN.

7. The method of claim 1, wherein the at least one NG-RAN is selected when the PDU session is created, when the UE is in a connected mode, when a user plane of the PDU session is activated, when the PDU session is modified, when the UE is registered, or when handover is performed.

8. The method of claim 1, wherein the QoS reservation profile is provided to the selected at least one NG-RAN when the PDU session is created.

9. The method of claim 1, wherein the QoS reservation profile is provided to the selected at least one NG-RAN when the AMF provides a QoS profile to a serving NG-RAN of the UE.

10. The method of claim 1, wherein when the at least one NG-RAN performs admission control, the QoS reservation profile is configured such that the at least one NG-RAN considers non-activated Flow/PDU session as being activated.

11. The method of claim 1, wherein the NG-RAN is determined based on at least one of network configuration information, region information, a moving path and a speed of the UE, and a network congestion level.

12. An access and mobility management function (AMF) device in a wireless communication system, the device comprising:
a memory; and
at least one processor coupled to the memory,
wherein the at least one processor is configured to:
select at least one next generation radio access network (NG-RAN) on a moving path of a user equipment (UE); and
provide a QoS reservation profile to the selected at least one NG-RAN,
wherein the QoS reservation profile includes at least one of information on the UE, information on a Flow/PDU session for which resource reservation is required, information on required QoS, a resource reservation start timing, and a resource reservation termination timing.
